(19) United States
(12) Patent Application Publication
(10) Pub. No.: US 2006/0061484 A1
(43) Pub. Date: Mar. 23, 2006

(54) Wireless system for notifying a driver of an oncoming emergency vehicle

(76) Inventors: Douglas D. Gutting, Indianapolis, IN (US); Kyle Cambridge, Indianapolis, IN (US)

Correspondence Address: ASHKAN NAJAFI, P.A., 6817 SOUTHPOINT PARKWAY, SUITE 2301, JACKSONVILLE, FL, 32216, US

(21) Appl. No.: 10/943,920

(22) Filed: Sep. 20, 2004

(51) Int. Cl. G08G 1/16; G08G 1/123

(52) U.S. Cl. 340/903; 340/988

(57) ABSTRACT

An emergency vehicle notification system includes a housing including a receiver stored therein and a power cord adapted for plugging into a 12-volt DC source. A central processing unit (CPU) is also disposed therein for executing a control logic. The system further includes a first wireless communication channel that transmits the coded signal from the emergency vehicle and a mechanism for determining a location and a travel velocity unique to the civilian vehicle as well as a location and a travel velocity unique to the emergency vehicle. Such a determining mechanism includes a second wireless communication channel for allowing the civilian vehicle to communicate with the emergency vehicle that operates at a frequency range unique from the first communication channel frequency range.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to a notifying system and, more particularly, to a wireless system for notifying a driver of an approaching emergency vehicle.

2. Prior Art

Emergency vehicles use sirens and flashing lights to warn other drivers of their approach or of their presence. There are many reasons why sirens and flashing lights do not provide adequate warnings. Flashing lights can only be seen where there is a direct line of sight and cannot be seen around corners in built-up metropolitan areas. Sirens cannot be heard by people who are hard of hearing or in vehicles where there is competing noise, such as a loud radio or noisy machinery or a different emergency vehicle that has its siren on.

Frequent collisions between emergency vehicles and other vehicles or even between two emergency vehicles responding to a call indicate that a siren or flashing lights alone are not adequate to warn all drivers of the presence or approach of the emergency vehicle. The consequences of a driver straying into the path of a rapidly moving emergency vehicle are so severe that there is a need for some additional way to warn drivers of the presence or approach of an emergency vehicle.

Furthermore, it is considered state-of-the-art automobile design to substantially eliminate external noise from the interior of present day automobiles to provide a quiet ride. Additionally, such vehicles often travel with their windows closed, and the air conditioner, radio, or other internal sound generating systems activated, thus rendering the warning devices of emergency vehicles inaudible or undetectable. Regardless of the reason, the number of accidents, injuries, and deaths resulting from collisions between emergency vehicles traveling in an emergency mode and other traffic becomes increasingly greater each year.

Accordingly, a need remains for a wireless system for notifying a driver of an approaching emergency vehicle in order to overcome the above-noted shortcomings. The present invention satisfies such a need by providing a notification system that is easy to install, effective in use and increases driver safety on the roads and highways. Such a notification system conveniently uses a radio frequency signaling transmitter and motorist receiver hardware to inform the driver of an approaching emergency vehicle in a timely and reliable fashion.

### BRIEF SUMMARY OF THE INVENTION

In view of the foregoing background, it is therefore an object of the present invention to provide a wireless system for notifying a driver of an oncoming emergency vehicle. These and other objects, features, and advantages of the invention are provided by a system for identifying a coded signal generated by an emergency vehicle so that civilian drivers approaching the emergency can advantageously be alerted in real-time.

The system includes a portable housing positionable in the civilian vehicle and further includes a receiver stored therein. Such a housing is provided with a power cord adapted for conveniently plugging into a 12-volt DC source and is electrically coupled to a speedometer of the civilian vehicle for detecting a real-time traveling velocity thereof. The housing further includes a central processing unit (CPU) disposed therein that is programmed for executing a control logic when the receiver receives the coded signal so that the system can effectively identify the source and location of the emergency vehicle. A first wireless communication channel transmits the coded signal from the emergency vehicle over a predetermined frequency range.

The system further includes a mechanism for determining a location and a travel velocity unique to the civilian vehicle as well as a location and a travel velocity unique to the emergency vehicle so that a real-time spatial relationship between the civilian driver and the emergency vehicle can be determined. Such a determining mechanism includes a second wireless communication channel for allowing the civilian vehicle to communicate with the emergency vehicle. The second communication channel operates at a frequency range unique from the first communication channel frequency range.

The determining mechanism preferably includes a direction sensor electrically coupled to the CPU that communicates therewith during operating conditions. Such a direction sensor is programmed for executing a global positioning satellite (GPS) logic when the coded signal is detected by the receiver. The direction sensor generates a signal and transmits the signal to the CPU for processing corresponding to an algorithm output performed by the GPS logic.

The determining mechanism preferably further includes an ignition controller operably connected to an ignition system of the civilian vehicle so that the system can advantageously be continuously powered while the vehicle is at an operating mode. A steering wheel controller may be operably connected to the housing for allowing the civilian driver to remotely control operating functions of the system during driving conditions.

The system may further include a plurality of LEDs electrically coupled to the housing that are selectively activated when the receiver detects a coded signal. Such LEDs are toggled between active and inactive modes corresponding to verified and unverified emergency vehicle signals. An audio device may be electrically coupled to the housing for cooperating with the LEDs when the verified emergency vehicle signal is detected during operating conditions. Such an audio device emits a predetermined message corresponding to the unique real-time location and travel velocity of the emergency vehicle and the spatial relationship with the civilian vehicle so that the civilian driver can conveniently be informed of potential hazards surrounding the immediate vicinity of the civilian vehicle.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a front elevational view showing a wireless system for notifying a driver of an oncoming emergency vehicle, in accordance with the present invention;

FIG. 2 is a rear elevational view of the system shown in FIG. 1;

FIG. 3 is an enlarged top plan view of the system shown in FIG. 1;

FIG. 4 is a schematic block diagram view of the system shown in FIG. 1;

FIG. 5 is a schematic block diagram view of the housing shown in FIG. 4;

FIG. 6 is a schematic block diagram view of the Central Processing Unit (CPU) in FIG. 5; and

FIG. 7 is a schematic block diagram view of the direction sensor shown in FIG. 5.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

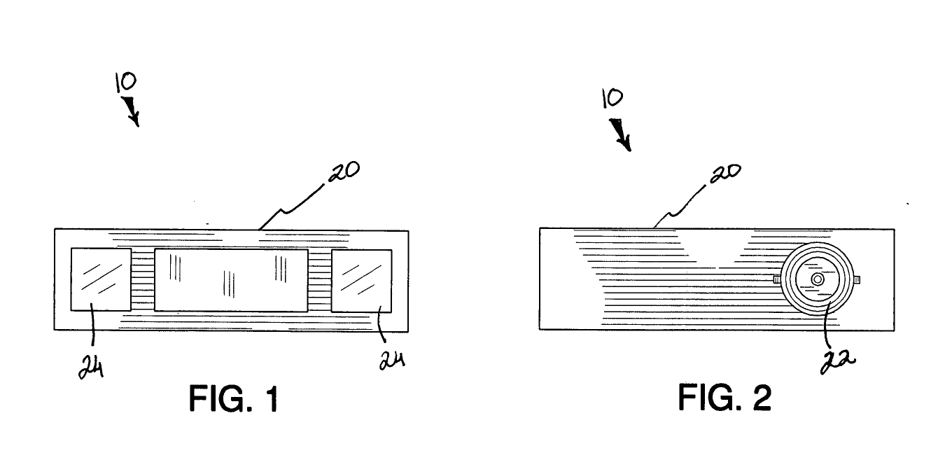

The system of this invention is referred to generally in FIGS. 1-7 by the reference numeral 10 and is intended to provide a wireless system for notifying a driver of an approaching emergency vehicle. It should be understood that the system 10 may be used to detect many different types of emergency vehicles and should not be limited to only ambulances.

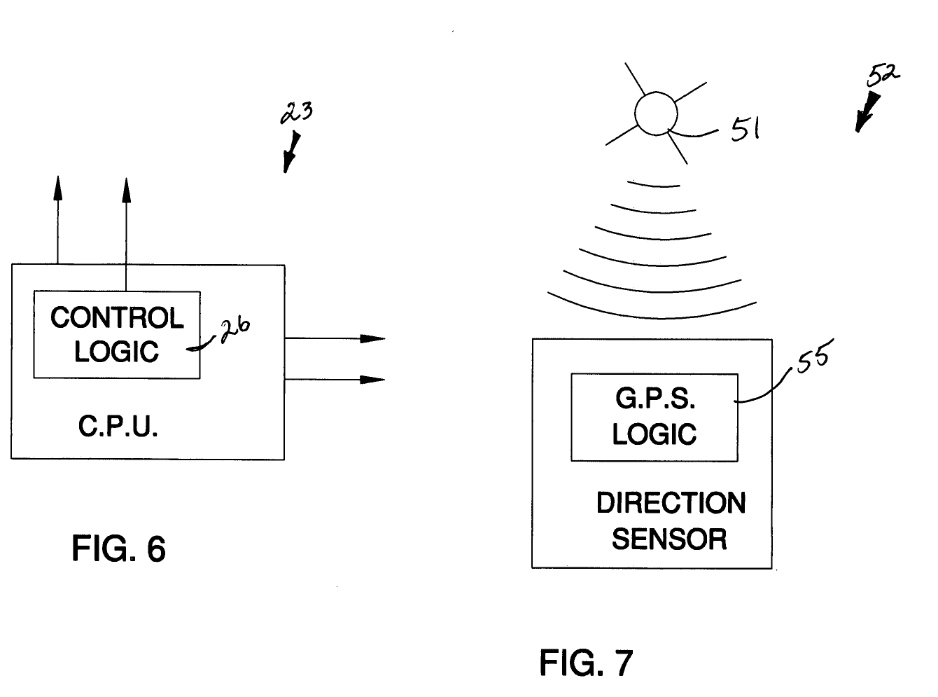

Referring initially to FIGS. 1 and 2, the system 10 includes a portable housing 20 positionable in the civilian vehicle (not shown) and further includes a receiver 21 stored therein. Of course, the system 10 may also be integrated into newly manufactured vehicles as a permanent feature. Such a housing 20 is provided with a power cord 22 adapted for conveniently plugging into a 12-volt DC source and is electrically coupled to a speedometer 31 of the civilian vehicle for detecting a real-time traveling velocity thereof. The housing 20 further includes a central processing unit 23 (CPU) disposed therein that is programmed for executing a control logic 26 when the receiver 21 receives the coded signal so that the system 10 can effectively identify the source and location of the emergency vehicle (not shown), as is best shown in FIG. 6. A first wireless communication channel 41 transmits the coded signal from the emergency vehicle over a predetermined frequency range.

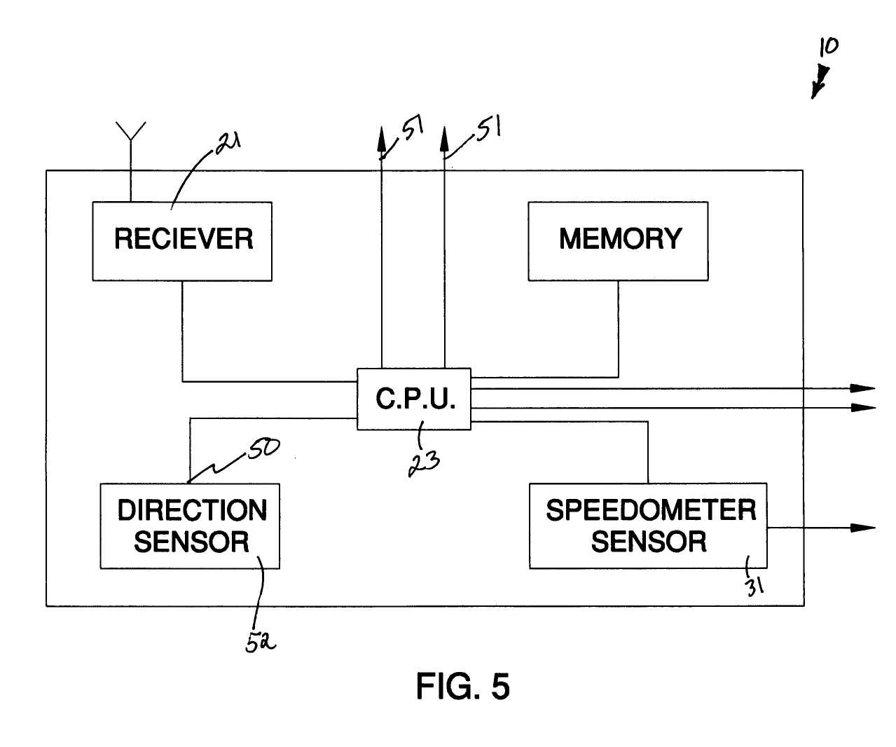

Referring to FIG. 5, the system 10 further includes a mechanism 50 for determining a location and a travel velocity unique to the civilian vehicle as well as a location and a travel velocity unique to the emergency vehicle so that a real-time spatial relationship between the civilian driver and the emergency vehicle can be determined. Such a determining mechanism 50 includes a second wireless communication channel 51 for allowing the civilian vehicle to communicate with the emergency vehicle. The second communication channel 51 operates at a frequency range unique from the first communication channel 41 frequency range, thus advantageously preventing the frequencies from interfering with each other and confusing the receiver 21 and allowing the system 10 to operate more efficiently.

Referring to FIGS. 5 and 7, the determining mechanism 50 includes a direction sensor 52 electrically coupled to the CPU 23 that communicates therewith during operating conditions. This feature advantageously allows a driver to be aware of the direction in which the emergency vehicle is approaching from Such a direction sensor 52 is programmed for executing a global positioning satellite (GPS) logic 55 when the coded signal is detected by the receiver 21. The direction sensor 52 generates a signal and transmits the signal to the CPU 23 for processing corresponding to an algorithm output performed by the GPS logic 55.

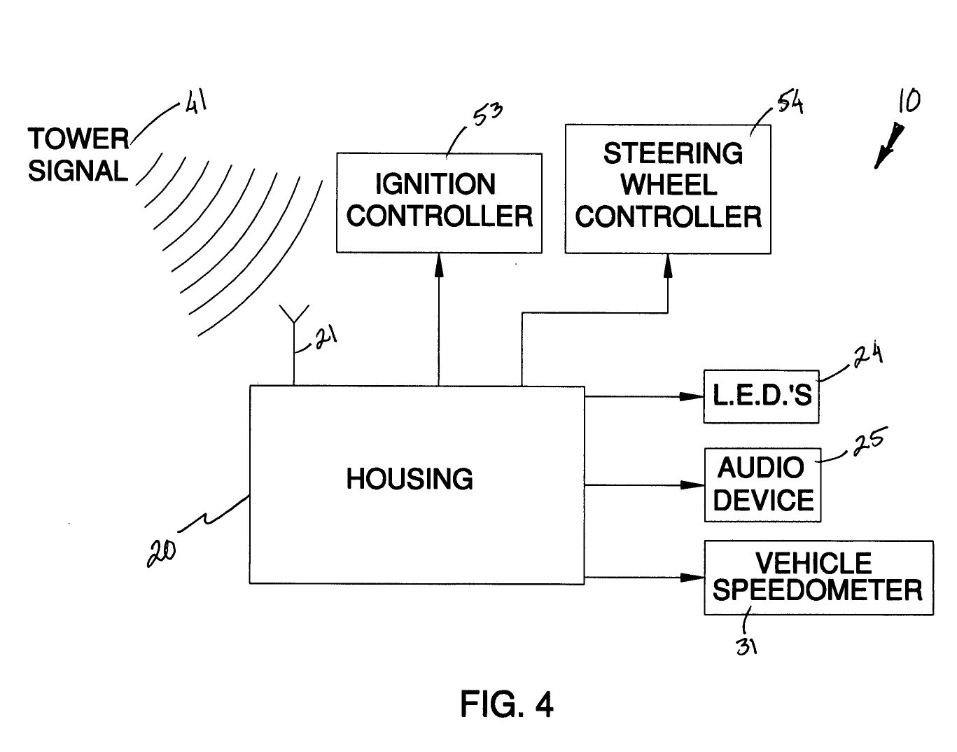

Referring to FIG. 4, the determining mechanism 50 further includes an ignition controller 53 operably connected to an ignition system (not shown) of the civilian vehicle so that the system 10 can advantageously be continuously powered while the vehicle is at an operating mode. This advantageously ensures that the driver is constantly receiving the full benefits of the activated system 10 in the event the driver forgets to initiate the system 10. A steering wheel controller 54 is operably connected to the housing 20 for allowing the civilian driver to remotely control operating functions of the system 10 during driving conditions. Such a steering wheel controller 54 advantageously allows the civilian driver to remain focused on the road while controlling the system 10, thus further increasing the safety features of the system 10.

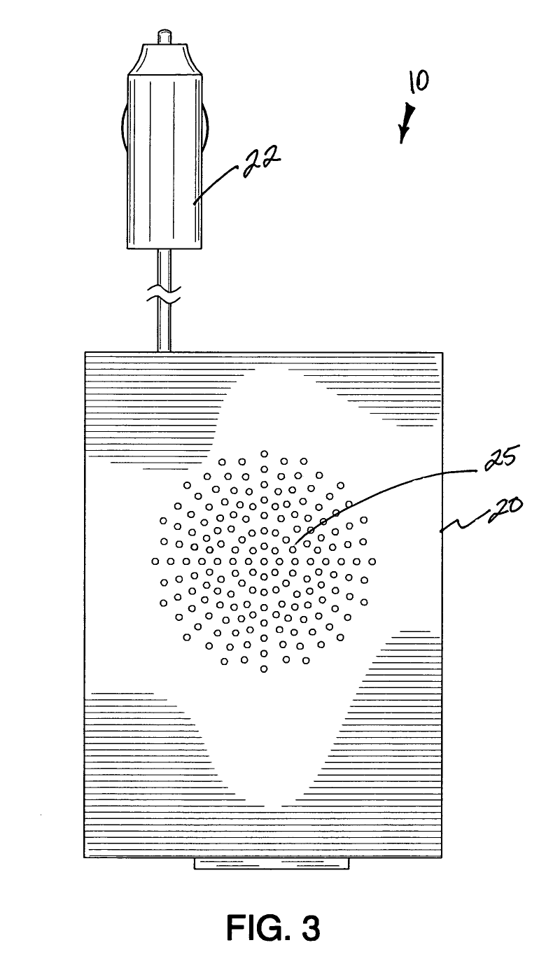

Referring to FIGS. 3 and 4, the system 10 further includes a plurality of LEDs 24 electrically coupled to the housing 20 that are selectively activated when the receiver 21 detects a coded signal. Such LEDs 24 are toggled between active and inactive modes corresponding to verified and unverified emergency vehicle signals. An audio device 25 is electrically coupled to the housing 20 for cooperating with the LEDs 24 when the verified emergency vehicle signal is detected during operating conditions. Such an audio device 25 emits a predetermined message corresponding to the unique real-time location and travel velocity of the emergency vehicle and the spatial relationship with the civilian vehicle so that the civilian driver can conveniently be informed of potential hazards surrounding the immediate vicinity of the civilian vehicle. The LEDs 24 and the audio device 25 ensure that the civilian driver knows that an emergency vehicle is either approaching or is positioned nearby. The LEDs also advantageously allow hearing impaired individuals to be aware of emergency situations in their vicinity.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

What is claimed as new and what is desired to secure by Letters Patent of the United States is:

1. A system for identifying a coded signal generated by an emergency vehicle so that civilian drivers approaching the emergency can be alerted in real-time, said system:
a portable housing positionable in the civilian vehicle and including a receiver stored therein, said housing being provided with a power cord adapted for plugging into a 12-volt DC source, said housing being electrically coupled to a speedometer of the civilian vehicle for detecting a real-time traveling velocity thereof, said housing comprising a central processing unit (CPU) disposed therein and being programmed for executing a control logic when said receiver receives the coded signal so that said system can identify a source and location of the emergency vehicle; and
means for determining a location and a travel velocity unique to the civilian vehicle as well as a location and a travel velocity unique to the emergency vehicle so that a real-time spatial relationship between the civilian driver and the emergency vehicle can be determined.

2. The system of claim 1, wherein said determining means comprises:
a direction sensor electrically coupled to said CPU and communicating therewith during operating conditions, said direction sensor being programmed for executing a global positioning satellite (GPS) logic when the coded signal is detected by said receiver, said direction sensor generating a signal and transmitting said signal to said CPU for processing corresponding to an algorithm output performed by the GPS logic.

3. The system of claim 2, wherein said determining means further comprises:
an ignition controller operably connected to an ignition system of the civilian vehicle so that said system can be continuously powered while the vehicle is at an operating mode; and
a steering wheel controller operably connected to said housing for allowing the civilian driver to remotely control operating functions of said system during driving conditions.

4. The system of claim 3, further comprising:
a plurality of LEDs electrically coupled to said housing and being selectively activated when said receiver detects a coded signal, said LEDs being toggled between active and inactive modes corresponding to verified and unverified emergency vehicle signals.

5. The system of claim 4, further comprising:
an audio device electrically coupled to said housing for cooperating with said LEDs when the verified emergency vehicle signal is detected during operating conditions, said audio device emitting a predetermined message corresponding to the unique real-time location and travel velocity of the emergency vehicle and the spatial relationship with the civilian vehicle so that the civilian driver can be informed of potential hazards surrounding the immediate vicinity of the civilian vehicle.

6. A system for identifying a coded signal generated by an emergency vehicle so that civilian drivers approaching the emergency can be alerted in real-time, said system:
a portable housing positionable in the civilian vehicle and including a receiver stored therein, said housing being provided with a power cord adapted for plugging into a 12-volt DC source, said housing being electrically coupled to a speedometer of the civilian vehicle for detecting a real-time traveling velocity thereof, said housing comprising a central processing unit (CPU) disposed therein and being programmed for executing a control logic when said receiver receives the coded signal so that said system can identify a source and location of the emergency vehicle;
a first wireless communication channel for transmitting and receiving the coded signal over a predetermined frequency range; and
means for determining a location and a travel velocity unique to the civilian vehicle as well as a location and a travel velocity unique to the emergency vehicle so that a real-time spatial relationship between the civilian driver and the emergency vehicle can be determined.

7. The system of claim 6, wherein said determining means comprises:
a direction sensor electrically coupled to said CPU and communicating therewith during operating conditions, said direction sensor being programmed for executing a global positioning satellite (GPS) logic when the coded signal is detected by said receiver, said direction sensor generating a signal and transmitting said signal to said CPU for processing corresponding to an algorithm output performed by the GPS logic.

8. The system of claim 7, wherein said determining means further comprises:
an ignition controller operably connected to an ignition system of the civilian vehicle so that said system can be continuously powered while the vehicle is at an operating mode; and
a steering wheel controller operably connected to said housing for allowing the civilian driver to remotely control operating functions of said system during driving conditions.

9. The system of claim 8, further comprising:
a plurality of LEDs electrically coupled to said housing and being selectively activated when said receiver detects a coded signal, said LEDs being toggled between active and inactive modes corresponding to verified and unverified emergency vehicle signals.

10. The system of claim 9, further comprising:
an audio device electrically coupled to said housing for cooperating with said LEDs when the verified emergency vehicle signal is detected during operating conditions, said audio device emitting a predetermined message corresponding to the unique real-time location and travel velocity of the emergency vehicle and the spatial relationship with the civilian vehicle so that the civilian driver can be informed of potential hazards surrounding the immediate vicinity of the civilian vehicle.

11. A system for identifying a coded signal generated by an emergency vehicle so that civilian drivers approaching the emergency can be alerted in real-time, said system:
a portable housing positionable in the civilian vehicle and including a receiver stored therein, said housing being provided with a power cord adapted for plugging into a 12-volt DC source, said housing being electrically coupled to a speedometer of the civilian vehicle for detecting a real-time traveling velocity thereof, said housing comprising a central processing unit (CPU) disposed therein and being programmed for executing a control logic when said receiver receives the coded signal so that said system can identify a source and location of the emergency vehicle;
a first wireless communication channel for transmitting the coded signal from the emergency vehicle and over a predetermined frequency range;
means for determining a location and a travel velocity unique to the civilian vehicle as well as a location and a travel velocity unique to the emergency vehicle so that a real-time spatial relationship between the civilian driver and the emergency vehicle can be determined, said determining means comprising a second wireless communication channel for allowing the civilian vehicle to communicate with the emergency vehicle, said second communication channel operating at a frequency range unique from said first communication channel frequency range.

12. The system of claim 11, wherein said determining means comprises:
a direction sensor electrically coupled to said CPU and communicating therewith during operating conditions, said direction sensor being programmed for executing a global positioning satellite (GPS) logic when the coded signal is detected by said receiver, said direction sensor generating a signal and transmitting said signal to said CPU for processing corresponding to an algorithm output performed by the GPS logic.

13. The system of claim 12, wherein said determining means further comprises:
an ignition controller operably connected to an ignition system of the civilian vehicle so that said system can be continuously powered while the vehicle is at an operating mode; and
a steering wheel controller operably connected to said housing for allowing the civilian driver to remotely control operating functions of said system during driving conditions.

14. The system of claim 13, further comprising:
a plurality of LEDs electrically coupled to said housing and being selectively activated when said receiver detects a coded signal, said LEDs being toggled between active and inactive modes corresponding to verified and unverified emergency vehicle signals.

15. The system of claim 14, further comprising:
an audio device electrically coupled to said housing for cooperating with said LEDs when the verified emergency vehicle signal is detected during operating conditions, said audio device emitting a predetermined message corresponding to the unique real-time location and travel velocity of the emergency vehicle and the spatial relationship with the civilian vehicle so that the civilian driver can be informed of potential hazards surrounding the immediate vicinity of the civilian vehicle.
